(19) United States
(12) Patent Application Publication
(10) Pub. No.: US 2025/0246927 A1
(43) Pub. Date: Jul. 31, 2025

(54) TWO-STAGE BATTERY CHARGER WITH MIDPOINT VOLTAGE REGULATION

(71) Applicant: Renesas Electronics America Inc., Milpitas, CA (US)

(72) Inventors: Sungkeun LIM, Apex, NC (US); Mehul Dilip SHAH, Cary, NC (US); Shahriar Jalal NIBIR, Apex, NC (US); Yen-Mo CHEN, Morrisville, NC (US)

(73) Assignee: Renesas Electronics America Inc., Milpitas, CA (US)

(21) Appl. No.: 18/423,528

(22) Filed: Jan. 26, 2024

(51) Int. Cl. H02J 7/00; H02M 1/00; H02M 3/158

(52) U.S. Cl. CPC H02J 7/00712; H02J 7/0047; H02M 1/0095; H02M 3/1582; H02J 2207/20

(57) ABSTRACT

Apparatuses, devices, and methods for operating a battery charger are described. A semiconductor device can include a controller that can monitor at least one battery parameter of a battery connected to a secondary stage of a two-stage battery charger. The controller can determine a threshold voltage based on the at least one battery parameter. The controller can regulate a midpoint voltage at the threshold voltage. The midpoint voltage can be provided by a primary stage of the two-stage battery charger to the secondary stage of the two-stage battery charger. The controller can operate the secondary stage in a non-switching mode to directly provide the midpoint voltage regulated at the threshold voltage to the battery.

### BACKGROUND

The present disclosure relates in general to semiconductor devices. More specifically, the present disclosure relates to operations of a two-stage battery charger that can reduce switching loss by regulating a midpoint volage between two stages in the two-stage battery charger.

A device that includes a battery can receive power for charging the battery, and/or for providing power to a load in the device or a load connected to the device. The power can be provided by a power adapter or various types of voltage source, such as universal serial bus (USB) adapters. In some aspects, the received power can provide an input voltage that can either be higher or lower than the voltage of the battery and/or voltage of the load. Internal power converters of the device can either step down or step up the input voltage in order to provide power with proper voltage level to the battery and the load. A controller, such as a microcontroller, can control operations of these internal power converters based on various quantitative measurements of the battery, the load, and other components of the device. The quantitative measurements can be used by the controller to perform control loops that can adjust parameters and/or settings of the internal power converters to optimize performances such as efficiency and power consumption, and to prevent hazardous conditions related to the battery charger.

### SUMMARY

In one embodiment, a semiconductor device for operating a battery charger is generally described. The semiconductor device can include a controller configured to monitor at least one battery parameter of a battery connected to a secondary stage of a two-stage battery charger. The controller can be further configured to determine a threshold voltage based on the at least one battery parameter. The controller can be further configured to regulate a midpoint voltage at the threshold voltage. The midpoint voltage can be provided by a primary stage of the two-stage battery charger to the secondary stage of the two-stage battery charger. The controller can be further configured to operate the secondary stage in a non-switching mode to directly provide the midpoint voltage regulated at the threshold voltage to the battery.

In one embodiment, a system for operating a battery charger is generally described. The system can include a battery module. The system can further include a primary stage configured to convert an input voltage into a midpoint voltage. The system can further include a secondary stage configured to convert the midpoint voltage into a system voltage for charging the battery module. The system can further include a controller. The controller can be configured to monitor at least one battery parameter of the battery. The controller can be further configured to determine a threshold voltage based on the at least one battery parameter. The controller can be further configured to regulate the midpoint voltage at the threshold voltage. The controller can be further configured to operate the secondary stage in a non-switching mode to directly provide the midpoint voltage regulated at the threshold voltage to the battery.

In one embodiment, a method for operating a battery charger is generally described. The method can include monitoring at least one battery parameter of a battery connected to a secondary stage of a two-stage battery charger. The method can further include comparing an input voltage being provided to a primary stage of the two-stage battery charger with a battery voltage of the battery, wherein the input voltage is among the at least one battery parameter. The method can further include, when the input voltage is less than the battery voltage, operating the secondary stage of the two-stage battery charger in a switching mode. The method can further include, when the input voltage is greater than the battery voltage, determining a threshold voltage based on the at least one battery parameter. The method can further include regulating a midpoint voltage at the threshold voltage. The midpoint voltage can be provided by a primary stage of the two-stage battery charger to the secondary stage of the two-stage battery charger. The method can further include operating the secondary stage in a non-switching mode to directly provide the midpoint voltage regulated at the threshold voltage to the battery.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an example diagram of a system that can implement two-stage battery charger with midpoint voltage regulation in one embodiment.

FIG. 2 is a diagram showing an implementation of the system of FIG. 1 in one embodiment.

FIG. 3 is an example diagram showing waveforms resulting from the implementation of FIG. 2 in one embodiment.

FIG. 4 is an example diagram of another system that can implement two-stage battery charger with midpoint voltage regulation in one embodiment.

FIG. 5 is a diagram showing an implementation of the system of FIG. 3 in one embodiment.

FIG. 6 is an example diagram showing waveforms resulting from the implementation of FIG. 5 in one embodiment.

FIG. 7 is a flow diagram illustrating a process to implement two-stage battery charger with midpoint voltage regulation in one embodiment.

FIG. 8 is a flow diagram illustrating another process to implement two-stage battery charger with midpoint voltage regulation in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

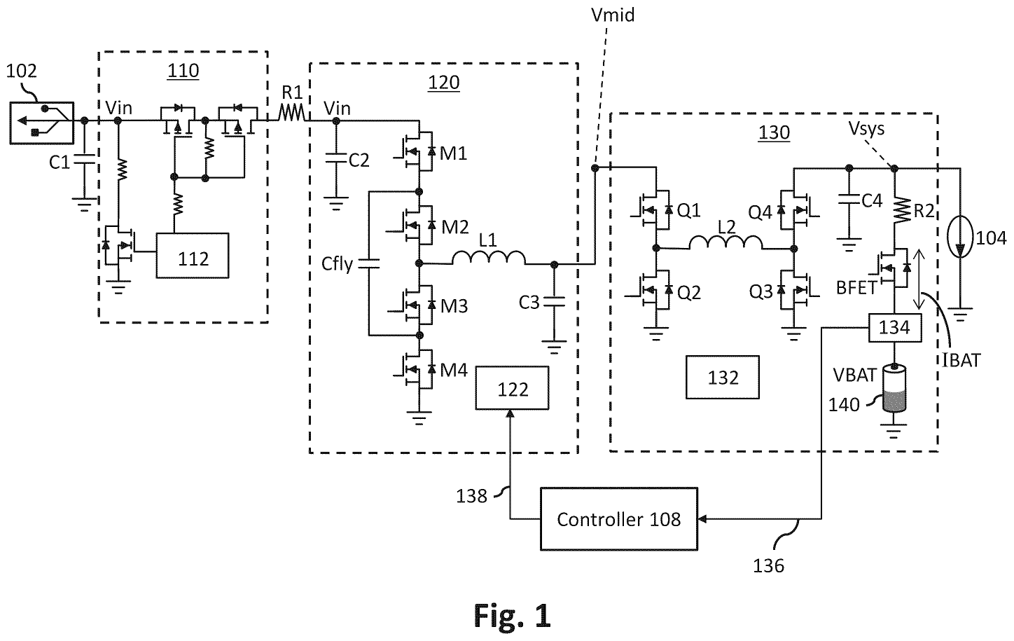

FIG. 1 is an example diagram of a system that can implement two-stage battery charger with midpoint voltage regulation in one embodiment. System 100 shown in FIG. 1 can be a two-state battery charging system implemented in a battery charger or a device including a battery module 140. System 100 can include a port 101, a power delivery circuit 110, a first stage 120, a second stage 130. In embodiments where system 100 is implemented in a device including battery module 140, battery module 140 can be a part of system 100. Port 101 can be a universal serial bus C-type (USB-C) port, or other types of port or adapter that can receive power from a power supply internal or external to system 100. In one embodiment, a load 104 can be connected to system 100 (e.g., connected to an output of second stage 130). In another embodiment, load 104 can be a part of system 100. Devices that can include system 100 can be an electronic device, such as, for example, a desktop computer, a laptop computer, a tablet device, a smartwatch, a cellular phone, a smartphone, a wearable device, an e-cigarette, or the like. Load 104 can be a component in the device that includes system 100, such as a component that operates under a specific voltage and draws current from battery module 140 and/or port 101. Battery module 140 can be a battery pack including at least one battery.

Power delivery (PD) circuit 110 can include a controller 112 that control various aspects of power delivery circuit 102, such as determining source and sink, negotiation and authentication for charging devices, determining charging direction, operating components such as switches in power delivery circuit 102, or the like. In one embodiment, PD circuit 110 can be an extended power range (EPR) power delivery (PD) adapter for USB-C ports that supports high voltage power delivery (e.g., universal serial bus power delivery (USB-PD) version 3.1. By way of example, input voltage Vin received by PD circuit via port 101 can be up to 48 volts (V) such that PD circuit 110 can output an adapter power up to 240 watts (W) with a maximum current limit set to 5 amperes (A). PD circuit 110 can output power having the input voltage Vin to first stage 120.

First stage 120 can be a first voltage conversion stage that converts input voltage Vin received at port 101 and provided by PD circuit 110 into a midpoint voltage Vmid. First stage 120 can be implemented by a multilevel switch converter, such as a three-level buck converter, formed by switching elements M1, M2, M3, M4 and a flying capacitor Cfly. Switching elements M1, M2, M3, M4 can be metal-oxide-semiconductor field-effect transistors (MOSFET) and can be connected in series. First stage 120 can include a controller 122. Controller 122 can be a three-level buck controller configured to switch switching elements M1, M2, M3, M4 and control a voltage of Cfly. By way of example, since first stage 120 is implemented as a three-level buck converter, first stage 120 can alternatively output its output voltage as voltages 0V, Vmid/2 and Vmid, where Vmid can be less than Vin. Controller 122 can be configured to perform one or more control loops to regulate Vmid at a target voltage level.

Second stage 130 can be a second voltage conversion stage that converts midpoint voltage Vmid into a system voltage Vsys. System voltage Vsys can be used for charging battery module 140 and/or load 104. In one embodiment, second stage 130 can be implemented by a narrow voltage direct charging (NVDC) battery charger (e.g., a NVDC 4-switch buck-boost battery charger). The combination of first stage 120 and second stage 130 can allow Vin provided by PD circuit 110 to be stepped down to lower voltage levels for loads that may require significant less operating voltage. In an aspect, the buck-boost converter in second stage 130 can have a maximum input voltage that is less than Vin (e.g., approximately 12V), hence cannot receive Vin directly. If Vin is 48V, then first stage 120 can first step down the input voltage of 48V to a Vmid of 12V and thereafter provide Vmid of 12V to second stage 130. The buck-boost converter in second stage 130 can step up or step down Vmid (e.g., 12V) to generate desired voltage levels of Vsys. Second stage 130 can include a controller 132. Controller 132 can be a two-level buck-boost controller configured to perform one or more control loops to control switching elements Q1, Q2, Q3, Q4 such that Vsys can be regulated at a target voltage level.

Controllers 112, 122, 132 can be, for example, microcontrollers. Controllers 112, 122, 132 can be implemented by one or more semiconductor devices. Each one of controllers 112, 122, 132 can include components, such as processors, logic circuits, digital to analog converters (DACs), comparators, mixers, memory devices (e.g., registers), and various electronic components. Controllers 112, 122, 132 can also include memory devices, such as registers, configured to store various predefined reference and threshold values that may be needed for executing various types of control loops including voltage control loops and current control loops. In one embodiment, controllers 112, 122, 132 can be configured to be in communication with one another. In one embodiment, controllers 112, 122, 132 can be parts of a single microcontroller. In one embodiment, controllers 112, 122, 132 can be connected to a controller 108, where controller 108 can be a microcontroller of a device including system 100. By way of example, if system 100 is part of a smartphone, controller 108 can include a central processing unit (CPU) of the smartphone and controllers 112, 122, 132 can be individual controllers on individual voltage converter integrated circuits (IC) implementing PD circuit 110, first stage 120 and second stage 130.

Second stage 130 can operate under various operation modes to generate Vsys. If battery module 140 is fully charged, controller 132 can turn off BFET. When the device including system 100 is on an on-the-go (OTG) mode, such as when port 101 is disconnected from any power source, controller 132 can turn on BFET to discharge battery module 140 to supply Vsys. In one embodiment, when port 101 connects system 100 to another device or load that may draw power from system 100, controller 132 can turn on BFET to discharge battery module 140 to provide power to the device connected to port 101 in a reverse mode. In a forward charging mode, controller 132 can turn on BFET, controller 122 can switch switching elements M1, M2, M3, M4 to convert Vin into Vmid, and controller 132 can switch switching elements Q1, Q2, Q3, Q4 to convert Vmid into Vsys for charging battery module 140.

Second stage 130 can further include a fuel gauge integrated circuit (FGIC) 134. FGIC 134 can be positioned between BFET and battery module 140. FGIC 134 can include one or more coulomb counters configured to measure and count various parameters of battery module 140, and convert the parameters into signals 136. Signals 136 can be analog or digital signals representing one or more of the parameters including, but not limited to, state of charge, battery capacity, remaining battery percentage, battery voltage (e.g., VBAT), battery current or charging current IBAT, battery health, battery temperature, estimated runtime, or other parameters of battery module 140.

In an aspect, when Vmid is less than a target voltage for VBAT, second stage 130 can step up Vmid to generate Vsys that can support VBAT. Similarly, when Vmid is greater than the target voltage for VBAT, second stage 130 can step down Vmid to generate Vsys that can support VBAT. Regardless of whether Vmid is greater than or less than the target voltage for VBAT, second stage 130 switches Q1, Q2, Q3, Q4 to perform the step up or step down. Controller 132 receive feedback of Vsys, VBAT, battery current or charging current IBAT, and other parameters relating to the output from second stage 130. Controller 132 can perform the switching in second stage 130 to regulate Vsys at a target voltage level of Vsys. Further, first stage 120 also switches M1, M2, M3, M4 to step down Vin into Vmid. Controller 122 receive feedback of Vmid and can perform the switching in first stage 120 to regulate Vmid at a target voltage level of Vmid.

When first stage 120 and second stage 120 are actively switching their respective switching elements, system 100 can experience switching losses and the switching losses can negatively impact the operational efficiency of system 100. To be described in more detail below, in order to reduce switching loss, controller 108 can receive signals 136 and use signals 136 to determine a threshold voltage 138. In one embodiment, threshold voltage 138 can be a target voltage for first stage 120 to regulate Vmid (e.g., it is desirable for Vmid to be regulated at threshold voltage 138). In addition to regulating Vmid based on signals 136, second stage 130 can operate in a non-switching operation mode, such as a pass through mode (PTM), where the regulated Vmid is directly provided to VBAT and/or Vsys without switching Q1, Q2, Q3, Q4 in second stage 130, thus reducing switching loss. Further, controller 108 can be configured to determine the conditions for second stage 130 to continue operating under switching mode or to operate under a non-switching mode such as PTM. As a result of monitoring the parameters of battery module 140 and using the monitored parameters to regulate Vmid, switching in second stage 130 can be avoided to reduce switching loss when compared to having both first stage 120 and second stage 130 operating in switching mode.

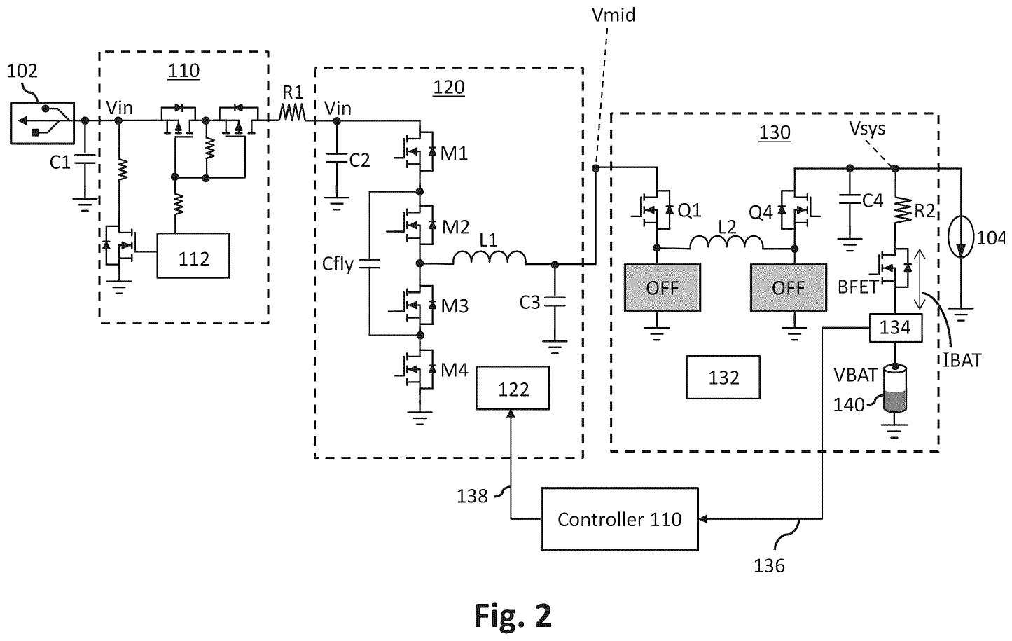

FIG. 2 is a diagram showing an implementation of the system of FIG. 1 in one embodiment. In one embodiment, signals 136 can include analog or digital signal representing at least battery voltage VBAT and charging current IBAT. Charging current IBAT can be a charging current for battery module 140. In the embodiment shown in FIG. 2, controller 108 can determine threshold voltage 138 using the following expression:

$$Vtar = VBAT + IBAT * ( R 2 + Rdson ( Q 1 + Q 4 + BFET ) )$$

where Vtar is the threshold voltage 138, R2 is the resistance of resistor R2 in second stage 130, Rdson (Q1+Q4+BFET) is a sum of the ON resistance of switching elements Q1, Q4, BFET (e.g., drain-source resistance of switching elements Q1, Q4, BFET when turned on). Note that the above expression for threshold voltage 138 considers a current path of IBAT that goes through resistor R2 and switching elements Q1, Q4, BFET. This current path is a current path of IBET when second stage 130 operates under a non-switching mode, such as PTM. Under PTM, the high-side switching elements Q1, Q4 in second stage 130 remains turned on and the low-side switching elements Q2, Q3 remains turned off, as shown in FIG. 2. Under the PTM, Vmid regulated at Vtar can be directly provided to battery module 140 for charging battery module 140 without switching the buck-boost converter in second stage 130.

In one embodiment, in response to a power supply being connected to port 101 for providing Vin, controller 108 can further measure input voltage Vin across resistor R1 between PD circuit 110 and first stage 120. Controller 108 can compare VBAT (indicated by signals 136) with input voltage Vin. If Vin is greater than VBAT, then controller 108 can determine that second stage 130 can operate under a non-switching mode. To operate second stage 130 in FIG. 2 under a non-switching mode such as PTM, controller 108 can notify controller 132 in second stage 130 to turn on switching elements Q1, Q4 and to turn off switching elements Q2, Q3 to operate second stage 130 in non-switching mode, such as PTM. Also in response to determination that second stage 130 in FIG. 2 can operate under a non-switching mode, controller 108 can disable first stage 120. In response to disabling first stage 120, controller 108 can determine threshold voltage 138 and send threshold voltage 138 to controller 122 in first stage 120 and also enable first stage 120. Controller 122 can receive threshold voltage 138 and, in response to the receipt of threshold voltage 138 and enable by controller 108, generate control signals (e.g., pulse width modulation (PWM) signals) to drive M1, M2, M3, M4 under specific switching sequence and duty cycles to regulate Vmid at threshold voltage 138.

As Vmid changes, charging current IBAT and battery voltage VBAT can also change, and FGIC 134 can continue to monitor IBAT and VBAT. Controller 108 can continue to receive signals 136 and monitor VBAT against Vin to determine whether second stage 130 in FIG. 2 shall continue to operate under a non-switching mode or revert back to switching mode. By way of example, when Vin is less than VBAT, then controller 108 can revert second stage 130 in FIG. 2 back to switching mode (e.g., as buck-boost converter) and notify controller 122 in first stage 120 to regulate Vmid without consideration of threshold voltage 138.

In one embodiment, when battery module 140 is fully discharged or when VBAT reaches a minimum VBAT value, charging battery module 140 too quickly (e.g., IBAT being too high) can damage battery module. To prevent damaging battery module 140, in additional to determining whether Vin is greater than VBAT, controller 108 can also determine whether battery module 140 is fully discharged (VBAT at a minimum value) or not in order to determine whether second stage 130 in FIG. 2 shall operate under a trickle charge mode before starting the non-switching mode. If Vin is greater than VBAT, and signals 136 indicate battery module 140 is fully discharged, then controller 108 can command controller 132 to control second stage 130 in FIG. 2 to operate under a trickle charge mode to slowly charge battery module 140. When VBAT reaches a voltage level that is considered a safe voltage level to charge battery module 140, and if Vin remains greater than VBAT, then controller 108 can disable first stage 120, command second stage 130 in FIG. 2 to go into non-switching mode and determine threshold volage 138 for Vmid regulation by first stage 120.

In one embodiment, when second stage 130 in FIG. 2 is operating under a non-switching mode such as PTM, controller 108 can perform a charging current control loop by monitoring charging current IBAT that can be indicated by signals 136. By way of example, if IBAT is greater than a predefined charging current threshold, then controller 108 can maintain threshold voltage 138 such that first stage 120 can regulate midpoint voltage Vmid at a current voltage level of Vtar. If IBAT is less than a predefined charging current threshold, then controller 108 can increase threshold voltage 138 such that first stage 120 can regulate midpoint voltage Vmid at a higher voltage level to increase charging current IBAT for charging battery module 140. The charging current control loop can allow battery module 140 to be charged using sufficient charging current.

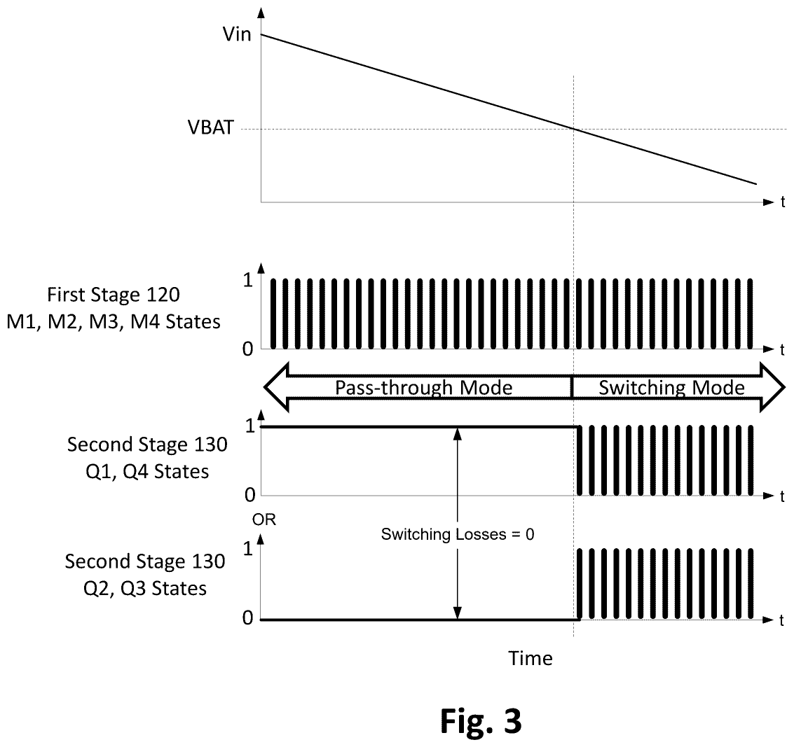

FIG. 3 is an example diagram showing waveforms resulting from the implementation of FIG. 2 in one embodiment. In an example shown in in FIG. 3, when Vin is greater than VBAT, second stage 130 can operate in a non-switching mode, such as pass-through mode. When second stage 130 operates under PTM, first stage 120 continues to operate in switching mode as shown by the states of switching elements M1, M2, M3, M4 varying between states 0 (e.g., off) and 1 (e.g., on). Also, when second stage 130 operates under PTM, switching elements Q1, Q4 in second stage 130 remains turned on and switching elements Q2, Q3 in second stage 130 remains turned off. When second stage 130 operates under PTM, the switching loss produced by second stage 130 can be zero. When Vin is less than VBAT, both first stage 120 and second stage 130 can operate under switching mode.

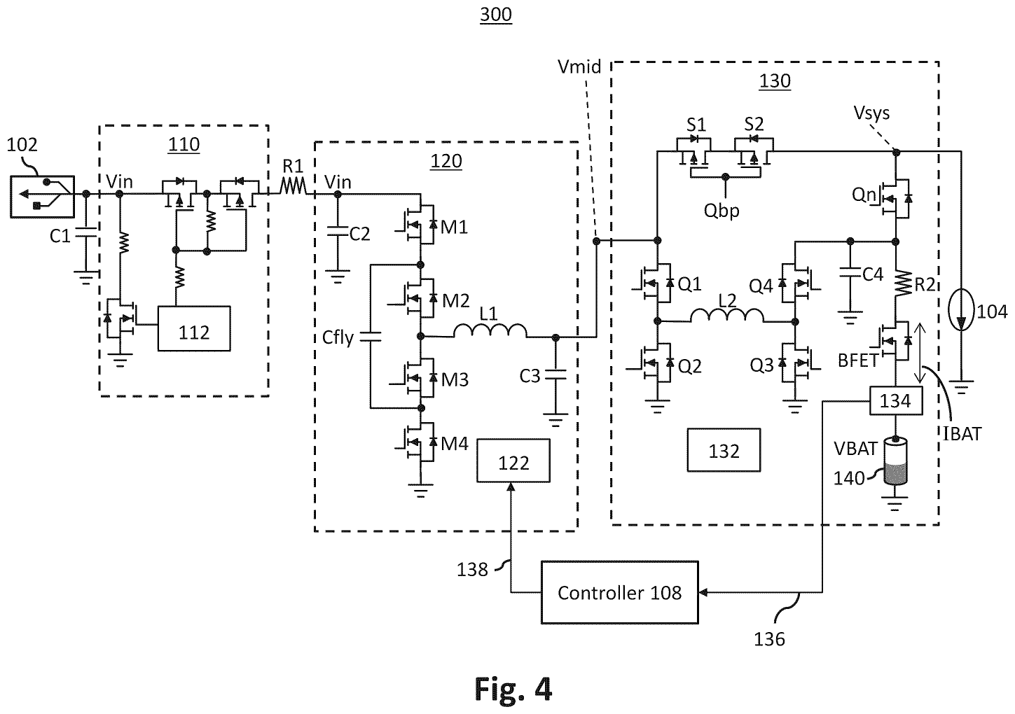

FIG. 4 is an example diagram of another system 300 that can implement two-stage battery charger with midpoint voltage regulation in one embodiment. In an embodiment shown in FIG. 4, second stage 130 can be implemented by a 4-switch hybrid power buck-boost (HPBB) bypass buck-boost converter formed by switching elements Q1, Q2, Q3, Q4 and a set of devices S1, S2 that can form a switching element Qbp, where S1, S2 can be MOSFETs. Controller 132 can turn on and off switching elements S1, S2 and can control a switching element Qn to connect and disconnect the switching S1, S2 to and from Vsys. Second stage 130 can operate the HPBB bypass buck-boost converter under various operation modes to generate Vsys.

In a bypass mode, the power of Vmid can be used for supporting both Vsys and for charging battery module 140. By way of example, when the power of Vmid is greater than the power of Vsys, the power of Vmid can support Vsys via S1,S2 and the remaining power from Vmid can be used for charging battery module 140 by switching Q1, Q2, Q3, Q4. When battery module 140 is not being charged, the switching of Q1, Q2, Q3, Q4 can be disabled, thus second stage 130 can be operated under a non-switching mode. In an NVDC mode, Vmid can support Vsys by switching Q1, Q2, Q3, Q4, while keeping S1, S2 off, to charge battery module 140. In an NVDC turbo mode, both Vmid and battery module 140 can support Vsys. In a reverse turbo boost (RTB) mode, Vmid may not be sufficient to support Vsys and battery module 140 can supplement Vmid by keeping BFET on to allow power to be provided from battery module 140 to Vsys. In a battery-only mode, which can also be an OTG mode, port 101 is disconnected from any power source and controller 132 can turn on BFET to discharge battery module 140 to supply Vsys. If battery module 140 is fully charged, controller 132 can turn off BFET.

Similar to system 100 shown in FIG. 1, in order to reduce switching loss, controller 108 can be configured to determine the conditions for second stage 130 to continue operating under switching mode or to operate under a non-switching mode where switching elements Q1, Q2, Q3, Q4 can be kept turned off while switching elements S1, S2 can be kept turned on. As a result of monitoring the parameters of battery module 140 and using the monitored parameters to regulate Vmid, switching in second stage 130 can be avoided to reduce switching loss when compared to having both first stage 120 and second stage 130 operating in switching mode.

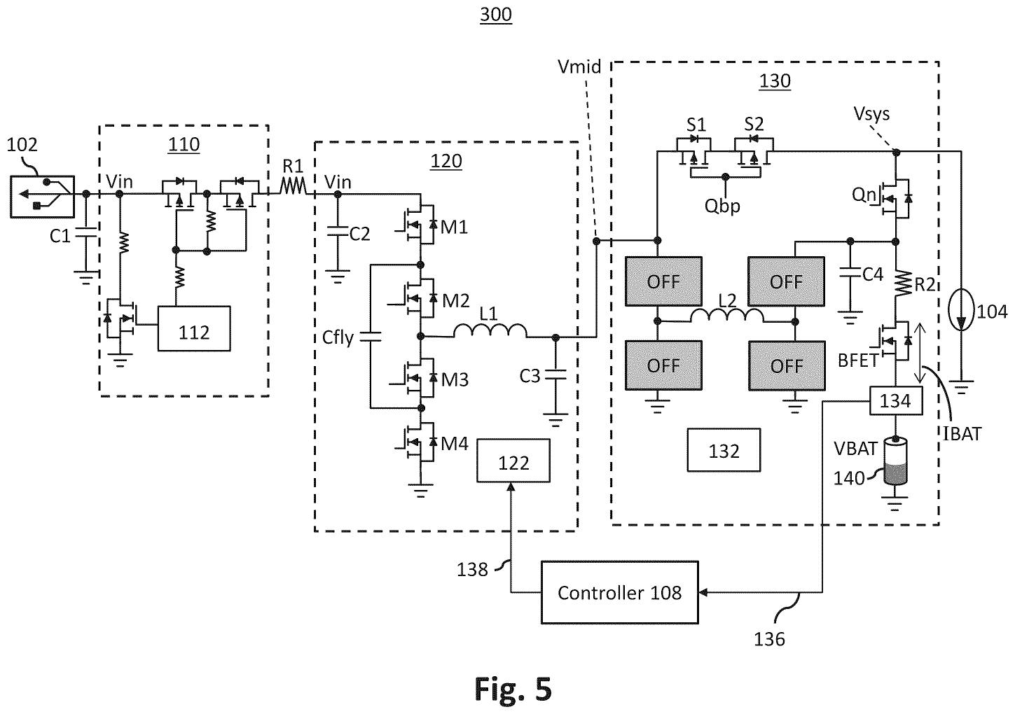

FIG. 5 is a diagram showing an implementation of the system of FIG. 3 in one embodiment. In one embodiment, signals 136 can include analog or digital signal representing at least battery voltage VBAT and charging current IBAT. Charging current IBAT can be a charging current for battery module 140. In the embodiment shown in FIG. 5, controller 108 can determine threshold voltage 138 using the following expression:

$$Vtar = VBAT + IBAT * ( R 2 + Rdson ( Q 1 + Q 4 + BFET ) )$$

where Vtar is the threshold voltage 138, R2 is the resistance of resistor R2 in second stage 130, Rdson (Qbp+Qn+BFET) is a sum of the ON resistance of switching elements Qbp, Qn, BFET (e.g., drain-source resistance of switching elements Qbp, Qn, BFET when turned on). Note that the above expression for threshold voltage 138 considers a current path of IBAT that goes through resistor R2 and switching elements Qbp, Qn, BFET. This current path is a current path of IBET when second stage 130 operates under a non-switching mode, such as the bypass mode with S1, S2 turned on and Q1, Q2, Q3, Q4 turned off. Under this non-switching mode, Vmid regulated at Vtar can be directly provided to battery module 140 for charging battery module 140 without switching being performed in second stage 130.

In one embodiment, in response to a power supply being connected to port 101 for providing Vin, controller 108 can further measure input voltage Vin across resistor R1 between PD circuit 110 and first stage 120. Controller 108 can compare VBAT (indicated by signals 136) with input voltage Vin. If Vin is greater than VBAT, then controller 108 can determine that second stage 130 can operate under a non-switching mode. To operate second stage 130 in FIG. 5 under a non-switching mode, controller 108 can notify controller 132 in second stage 130 to turn on switching elements S1, S2 and to turn off switching elements Q1, Q2, Q3, Q4 to operate second stage 130 in non-switching mode. Also in response to determination that second stage 130 in FIG. 5 can operate under a non-switching mode, controller 108 can disable first stage 120. In response to disabling first stage 120, controller 108 can determine threshold voltage 138 and send threshold voltage 138 to controller 122 in first stage 120 and also enable first stage 120. Controller 122 can receive threshold voltage 138 and, in response to the receipt of threshold voltage 138 and enable by controller 108, generate control signals (e.g., pulse width modulation (PWM) signals) to drive M1, M2, M3, M4 under specific switching sequence and duty cycles to regulate Vmid at threshold voltage 138.

As Vmid changes, charging current IBAT and battery voltage VBAT can also change, and FGIC 134 can continue to monitor IBAT and VBAT. Controller 108 can continue to receive signals 136 and monitor VBAT against Vin to determine whether second stage 130 in FIG. 5 shall continue to operate under a non-switching mode or revert back to switching mode. By way of example, when Vin is less than VBAT, then controller 108 can revert second stage 130 in FIG. 5 back to switching mode (e.g., as buck-boost converter) and notify controller 122 in first stage 120 to regulate Vmid without consideration of threshold voltage 138.

In one embodiment, when battery module 140 is fully discharged or when VBAT reaches a minimum VBAT value, charging battery module 140 too quickly (e.g., IBAT being too high) can damage battery module. To prevent damaging battery module 140, in additional to determining whether Vin is greater than VBAT, controller 108 can also determine whether battery module 140 is fully discharged (VBAT at a minimum value) or not in order to determine whether second stage 130 in FIG. 5 shall operate under a trickle charge mode before starting the non-switching mode. If Vin is greater than VBAT, and signals 136 indicate battery module 140 is fully discharged, then controller 108 can command controller 132 to control second stage 130 in FIG. 5 to operate under a trickle charge mode to slowly charge battery module 140. When VBAT reaches a voltage level that is considered a safe voltage level to charge battery module 140, and if Vin remains greater than VBAT, then controller 108 can disable first stage 120, command second stage 130 in FIG. 5 to go into non-switching mode and determine threshold volage 138 for Vmid regulation by first stage 120.

In one embodiment, when second stage 130 in FIG. 5 is operating under a non-switching mode where Q1, Q2, Q3, Q4 are turned off and S1, S2 are turned on, controller 108 can perform a charging current control loop by monitoring charging current IBAT that can be indicated by signals 136. By way of example, if IBAT is greater than a predefined charging current threshold, then controller 108 can maintain threshold voltage 138 such that first stage 120 can regulate midpoint voltage Vmid at a current voltage level of Vtar. If IBAT is less than a predefined charging current threshold, then controller 108 can increase threshold voltage 138 such that first stage 120 can regulate midpoint voltage Vmid at a higher voltage level to increase charging current IBAT for charging battery module 140. The charging current control loop can allow battery module 140 to be charged using sufficient charging current.

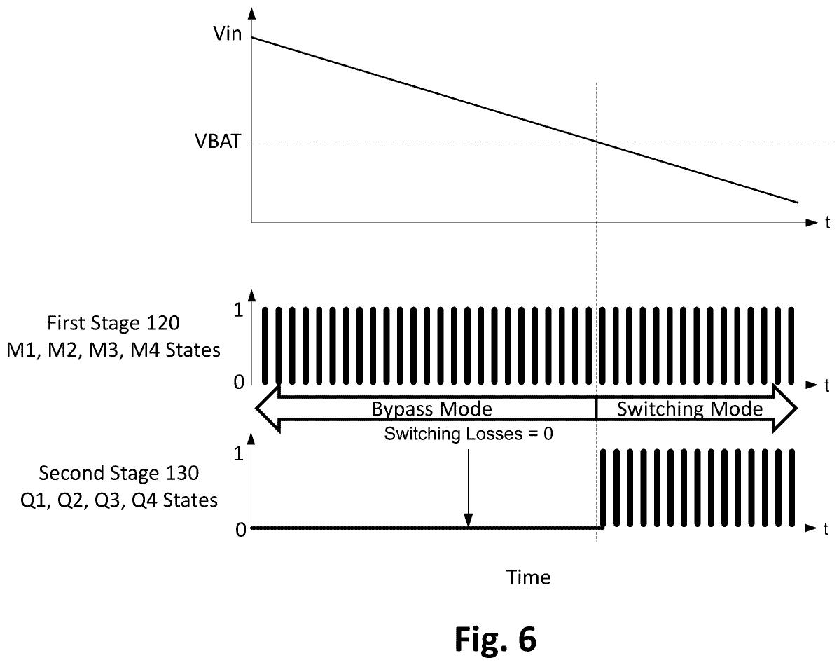

FIG. 6 is an example diagram showing waveforms resulting from the implementation of FIG. 5 in one embodiment. In an example shown in in FIG. 6, when Vin is greater than VBAT, second stage 130 can operate in a non-switching mode, such as the bypass mode. When second stage 130 operates under the bypass mode, first stage 120 continues to operate in switching mode as shown by the states of switching elements M1, M2, M3, M4 varying between states 0 (e.g., off) and 1 (e.g., on). Also, when second stage 130 operates under the bypass mode, switching elements Q1, Q2, Q3, Q4 in second stage 130 remains turned off (S1, S2 remains turned on). When second stage 130 operates under the bypass mode, the switching loss produced by second stage 130 can be zero. When Vin is less than VBAT, both first stage 120 and second stage 130 can operate under switching mode.

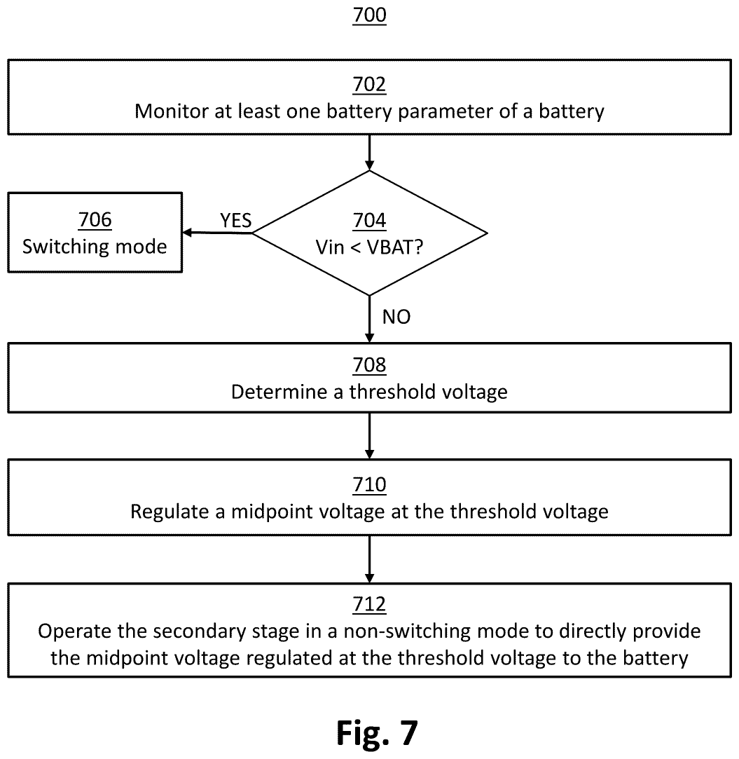

FIG. 7 is a flow diagram illustrating a process to implement two-stage battery charger with midpoint voltage regulation in one embodiment. Description of FIG. 7 can reference components shown in FIG. 1 to FIG. 6. The process 700 can include one or more operations, actions, or functions as illustrated by one or more of blocks 702, 704, 706, 708, 710 and/or 712. Although illustrated as discrete blocks, various blocks may be divided into additional blocks, combined into fewer blocks, eliminated, performed in different order, or performed in parallel, depending on the desired implementation.

Process 700 can be performed by one or more controllers, such as controller 108 or a combination of controllers 108, 112, 122, 132 shown in at least one of FIG. 1 to FIG. 6. Process 700 can begin at block 702. At block 702, a controller can monitor at least one battery parameter of a battery connected to a secondary stage of a two-stage battery charger. In one embodiment, the at least one battery parameter can include the battery voltage and a charging current of the battery.

Process 700 can proceed from block 702 to block 704. At block 704, the controller can compare an input voltage Vin being provided to a primary stage of the two-stage battery charger with a battery voltage of the battery VBAT. The input voltage Vin can be among the at least one battery parameter monitored in block 702.

When the input voltage Vin is less than the battery voltage VBAT, process 700 can proceed from block 704 to block 706. At block 706, the controller can operate the secondary stage of the two-stage battery charger in a switching mode.

When the input voltage Vin is greater than the battery voltage VBAT, process 700 can proceed from block 704 to block 708. At block 708, the controller can determine a threshold voltage based on the at least one battery parameter. In one embodiment, the controller can determine the threshold voltage based on at least a battery voltage of the battery, a battery current of the battery, a resistance of a sense resistor connected to the battery, and an ON resistance of at least one switching elements that is turned on in the non-switching mode.

Process 700 can proceed from block 708 to block 710. At block 710, the controller can regulate a midpoint voltage at the threshold voltage. The midpoint voltage can be provided by a primary stage of the two-stage battery charger to the secondary stage of the two-stage battery charger.

Process 700 can proceed from block 710 to block 712. At block 712, the controller can operate the secondary stage in a non-switching mode to directly provide the midpoint voltage regulated at the threshold voltage to the battery.

In one embodiment, the primary stage can include a three-level buck converter and the secondary stage can include a two-level buck-boost converter. The non-switching mode can be a pass-through mode where high-side switching elements in the secondary stage remains turned on and low-side switching elements in the secondary stage remains turned off.

In one embodiment, the primary stage can include a three-level buck converter and the secondary stage can include a hybrid power buck-boost (HPBB) bypass buck-boost converter. The non-switching mode can be a bypass mode where a buck-boost converter in the secondary stage is turned off and a set of bypass switching elements in the secondary stage remains turned on.

In one embodiment, the controller can determine a battery voltage of the battery reaches a minimum value. The controller can operate the secondary stage of the two-stage battery charger in a trickle charge mode. The controller can determine the battery voltage reaches a safe voltage level. The controller can determine the threshold voltage and operate the secondary stage of the two-stage battery charger in the non-switching mode.

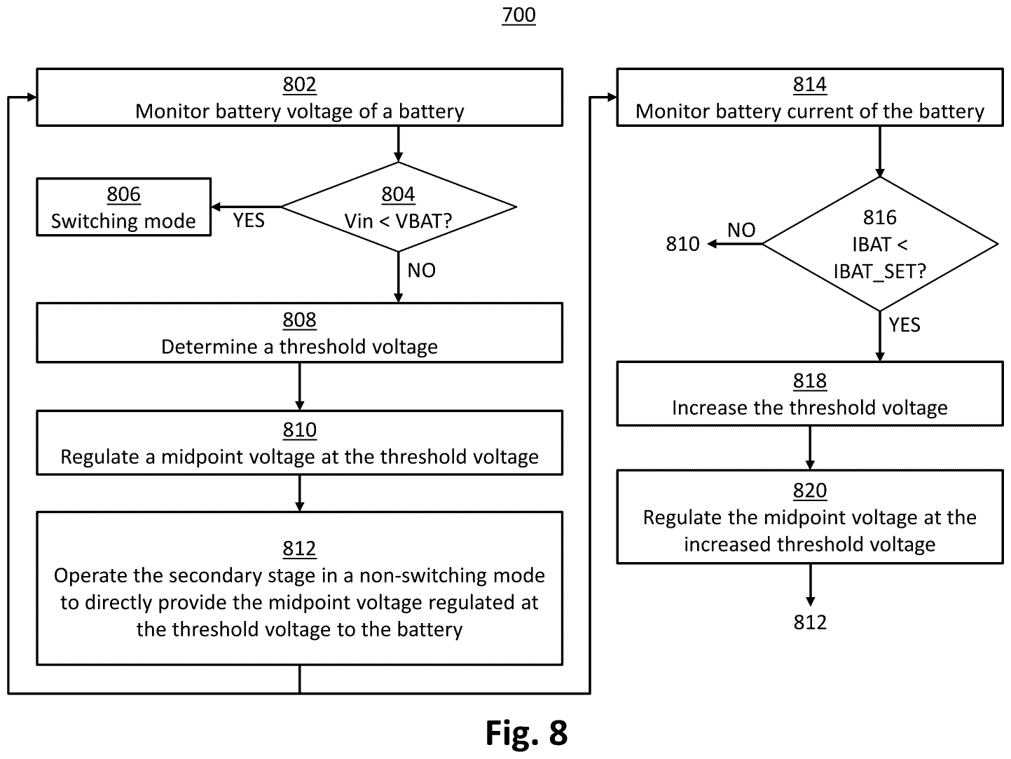

FIG. 8 is a flow diagram illustrating another process to implement two-stage battery charger with midpoint voltage regulation in one embodiment. Description of FIG. 8 can reference components shown in FIG. 1 to FIG. 6. The process 800 can include one or more operations, actions, or functions as illustrated by one or more of blocks 802, 804, 806, 808, 810, 812, 814, 816, 818 and/or 820. Although illustrated as discrete blocks, various blocks may be divided into additional blocks, combined into fewer blocks, eliminated, performed in different order, or performed in parallel, depending on the desired implementation.

Process 800 can be performed by one or more controllers, such as controller 108 or a combination of controllers 108, 112, 122, 132 shown in at least one of FIG. 1 to FIG. 6. Process 800 can begin at block 802. At block 802, a controller can monitor a battery voltage VBAT of a battery connected to a secondary stage of a two-stage battery charger.

Process 800 can proceed from block 802 to block 804. At block 804, the controller can compare an input voltage Vin being provided to a primary stage of the two-stage battery charger with the battery voltage of the battery VBAT.

When the input voltage Vin is less than the battery voltage VBAT, process 800 can proceed from block 804 to block 806. At block 806, the controller can operate the secondary stage of the two-stage battery charger in a switching mode.

When the input voltage Vin is greater than the battery voltage VBAT, process 800 can proceed from block 804 to block 808. At block 808, the controller can determine a threshold voltage based on the at least one battery parameter. In one embodiment, the controller can determine the threshold voltage based on at least a battery voltage of the battery, a battery current of the battery, a resistance of a sense resistor connected to the battery, and an ON resistance of at least one switching elements that is turned on in the non-switching mode.

Process 800 can proceed from block 808 to block 810. At block 810, the controller can regulate a midpoint voltage at the threshold voltage. The midpoint voltage can be provided by a primary stage of the two-stage battery charger to the secondary stage of the two-stage battery charger.

Process 800 can proceed from block 810 to block 812. At block 812, the controller can operate the secondary stage in a non-switching mode to directly provide the midpoint voltage regulated at the threshold voltage to the battery.

Process 800 can proceed from block 812 to block 814. At block 814, under the non-switching mode in block 812, the controller can monitor a battery charging current IBAT of the battery connected to a secondary stage of a two-stage battery charger.

Process 800 can proceed from block 814 to block 816. At block 816, the controller can compare the charging current IBAT with a predefined charging current threshold IBAT_SET.

When the charging current IBAT is equal to or greater than IBAT_SET, process 800 can return to block 810 to continue regulating the midpoint voltage at the threshold voltage.

When the charging current IBAT is less than IBAT_SET, process 800 can proceed from block 816 to block 818. At block 818, the controller can increase the threshold voltage.

Process 800 can proceed from block 808 to block 820. At block 820, the controller can regulate the midpoint voltage at the increased threshold voltage. Process 800 can continue to block 812 where the controller operates the second stage under the non-switching mode using the regulated midpoint voltage.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a controller configured to:
monitor at least one battery parameter of a battery connected to a secondary stage of a two-stage battery charger;
determine a threshold voltage based on the at least one battery parameter;
regulate a midpoint voltage at the threshold voltage, wherein the midpoint voltage is being provided by a primary stage of the two-stage battery charger to the secondary stage of the two-stage battery charger; and
operate the secondary stage in a non-switching mode to directly provide the midpoint voltage regulated at the threshold voltage to the battery.

2. The semiconductor device of claim 1, wherein:
the primary stage comprises a three-level buck converter; and
the secondary stage comprises a two-level buck-boost converter, wherein the non-switching mode is a pass-through mode where high-side switching elements in the secondary stage remains turned on and low-side switching elements in the secondary stage remains turned off.

3. The semiconductor device of claim 1, wherein:
the primary stage comprises a three-level buck converter; and
the secondary stage comprises a hybrid power buck-boost (HPBB) bypass buck-boost converter, wherein the non-switching mode is a bypass mode where a buck-boost converter in the secondary stage is turned off and a set of bypass switching elements in the secondary stage remains turned on.

4. The semiconductor device of claim 1, wherein the at least one battery parameter comprises a battery voltage of the battery and a charging current of the battery.

5. The semiconductor device of claim 1, wherein the controller is configured to determine the threshold voltage based on at least a battery voltage of the battery, a battery current of the battery, a resistance of a sense resistor connected to the battery, and an ON resistance of at least one switching elements that is turned on in the non-switching mode.

6. The semiconductor device of claim 1, wherein the controller is configured to:
compare an input voltage being provided to the primary stage with a battery voltage of the battery;
when the input voltage is greater than the battery voltage:
determine the threshold voltage; and
operate the secondary stage of the two-stage battery charger in the non-switching mode; and
when the input voltage is less than the battery voltage, operate the secondary stage of the two-stage battery charger in a switching mode.

7. The semiconductor device of claim 1, wherein the controller is configured to:
determine a battery voltage of the battery reaches a minimum value;
operate the secondary stage of the two-stage battery charger in a trickle charge mode;
determine the battery voltage reaches a safe voltage level; and
determine the threshold voltage; and
operate the secondary stage of the two-stage battery charger in the non-switching mode.

8. A system comprising:
a battery module;
a primary stage configured to convert an input voltage into a midpoint voltage;
a secondary stage configured to convert the midpoint voltage into a system voltage for charging the battery module;
a controller configured to:
monitor at least one battery parameter of the battery;
determine a threshold voltage based on the at least one battery parameter;
regulate the midpoint voltage at the threshold voltage; and
operate the secondary stage in a non-switching mode to directly provide the midpoint voltage regulated at the threshold voltage to the battery.

9. The system of claim 8, wherein:
the primary stage comprises a three-level buck converter; and
the secondary stage comprises a two-level buck-boost converter, wherein the non-switching mode is a pass-through mode where high-side switching elements in the secondary stage remains turned on and low-side switching elements in the secondary stage remains turned off.

10. The system of claim 8, wherein:
the primary stage comprises a three-level buck converter; and
the secondary stage comprises a hybrid power buck-boost (HPBB) bypass buck-boost converter, wherein the non-switching mode is a bypass mode where a buck-boost converter in the secondary stage is turned off and a set of bypass switching elements in the secondary stage remains turned on.

11. The system of claim 8, wherein the at least one battery parameter comprises a battery voltage of the battery and a charging current of the battery.

12. The system of claim 8, wherein the controller is configured to determine the threshold voltage based on at least a battery voltage of the battery, a battery current of the battery, a resistance of a sense resistor connected to the battery, and an ON resistance of at least one switching elements that is turned on in the non-switching mode.

13. The system of claim 8, wherein the controller is configured to:
compare an input voltage being provided to the primary stage with a battery voltage of the battery;
when the input voltage is greater than the battery voltage:
determine the threshold voltage; and
operate the secondary stage in the non-switching mode; and
when the input voltage is less than the battery voltage, operate the secondary stage in a switching mode.

14. The system of claim 8, wherein the controller is configured to:
determine a battery voltage of the battery reaches a minimum value;
operate the secondary stage of the two-stage battery charger in a trickle charge mode;
determine the battery voltage reaches a safe voltage level;
determine the threshold voltage; and
operate the secondary stage of the two-stage battery charger in the non-switching mode.

15. A method for operating a battery charger, the method comprising:
monitoring at least one battery parameter of a battery connected to a secondary stage of a two-stage battery charger;
comparing an input voltage being provided to a primary stage of the two-stage battery charger with a battery voltage of the battery, wherein the input voltage is among the at least one battery parameter;
when the input voltage is less than the battery voltage, operating the secondary stage of the two-stage battery charger in a switching mode;
when the input voltage is greater than the battery voltage:
determining a threshold voltage based on the at least one battery parameter;
regulating a midpoint voltage at the threshold voltage, wherein the midpoint voltage is being provided by a primary stage of the two-stage battery charger to the secondary stage of the two-stage battery charger; and
operating the secondary stage in a non-switching mode to directly provide the midpoint voltage regulated at the threshold voltage to the battery.

16. The method of claim 15, wherein:
the primary stage comprises a three-level buck converter; and
the secondary stage comprises a two-level buck-boost converter, wherein the non-switching mode is a pass-through mode where high-side switching elements in the secondary stage remains turned on and low-side switching elements in the secondary stage remains turned off.

17. The method of claim 15, wherein:
the primary stage comprises a three-level buck converter; and
the secondary stage comprises a hybrid power buck-boost (HPBB) bypass buck-boost converter, wherein the non-switching mode is a bypass mode where a buck-boost converter in the secondary stage is turned off and a set of bypass switching elements in the secondary stage remains turned on.

18. The method of claim 15, wherein the at least one battery parameter comprises the battery voltage and a charging current of the battery.

19. The method of claim 15, further comprising determining the threshold voltage based on at least a battery voltage of the battery, a battery current of the battery, a resistance of a sense resistor connected to the battery, and an ON resistance of at least one switching elements that is turned on in the non-switching mode.

20. The method of claim 15, further comprising:
determining a battery voltage of the battery reaches a minimum value;
operating the secondary stage of the two-stage battery charger in a trickle charge mode;
determining the battery voltage reaches a safe voltage level; and
determining the threshold voltage; and
operating the secondary stage of the two-stage battery charger in the non-switching mode.
